(19) United States
(12) Patent Application Publication
(10) Pub. No.: US 2017/0132557 A1
(43) Pub. Date: May 11, 2017

(54) METHODS AND SYSTEMS FOR EVALUATING AN INCIDENT TICKET

(71) Applicant: Wipro Limited, Bangalore (IN)

(72) Inventors: Arthi Venkataraman, Bangalore (IN); Ramkumar Balasubramanian, Bangalore (IN)

(21) Appl. No.: 14/984,939

(22) Filed: Dec. 30, 2015

(30) Foreign Application Priority Data
Nov. 5, 2015 (IN) 5992/CHE/2015

(51) Int. Cl. G06Q 10/06; G06Q 30/02

(52) U.S. Cl. CPC G06Q 10/063114; G06Q 30/0282

(57) ABSTRACT

This disclosure relates generally to incident management, and more particularly to methods and systems for evaluating an incident ticket. In one embodiment, an incident evaluating device for evaluating an incident ticket is disclosed. The incident evaluating device comprises a processor and a memory communicatively coupled to the processor. The memory stores processor instructions, which, on execution, causes the processor to analyze data associated with the incident ticket. The processor determines completeness of incident resolution of the incident ticket based on the analysis and rates the incident ticket based on the completeness of the incident resolution.

This application claims the benefit of Indian Patent Application Serial No. 5992/CHE/2015 filed Nov. 5, 2015, which is hereby incorporated by reference in its entirety.

### FIELD

This disclosure relates generally to incident management, and more particularly to methods and systems for evaluating an incident ticket.

### BACKGROUND

An incident management process aims at providing effective incident resolution to ensure quality of service provided to customers. The incident management process includes the incident resolution and evaluation of the incident resolution. The evaluation of the incident resolution requires consideration of a plurality of factors affecting quality of the incident resolution. The existing incident management processes do not provide a means for identifying the plurality of factors. As the plurality of factors are not identified, the evaluation of the incident resolution consumes more time, thereby leading to a significant increase in time taken for the incident management process.

Further, in the existing incident management process, quality of the incident resolution is assessed manually based on a feedback provided by a user. As the assessment is manual, the time consumed in the evaluation of the incident resolution is high. Also, the existing incident management processes do not provide a quantitative measure of the evaluation of the incident ticket. As the evaluation is not quantitative outcome of the evaluation may not be precise or objective.

### SUMMARY

In one embodiment, a method for evaluating an incident ticket is disclosed. The method comprises analyzing, by an incident evaluating device, data associated with the incident ticket. The method comprises determining, by the incident evaluating device, completeness of incident resolution of the incident ticket based on the analysis. The method further comprises rating, by the incident evaluating device, the incident ticket based on the completeness of the incident resolution.

In one embodiment, an incident evaluating device for evaluating an incident ticket is disclosed. The incident evaluating device comprises a processor and a memory communicatively coupled to the processor. The memory stores processor instructions, which, on execution, causes the processor to analyze data associated with the incident ticket. The processor determines completeness of incident resolution of the incident ticket based on the analysis and rates the incident ticket based on the completeness of the incident resolution.

In one embodiment, a non-transitory computer-readable medium storing computer-executable instructions is disclosed. The instructions comprises instructions for analyzing data associated with the incident ticket, determining completeness of incident resolution of the incident ticket based on the analysis, and rating the incident ticket based on the completeness of the incident resolution.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation comprising an incident evaluating device for evaluating an incident ticket according to some embodiments of the present disclosure.

FIG. 2 is a flow diagram illustrating an example of a method for evaluating the incident ticket in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present subject matter discloses systems and methods for evaluating an incident ticket. The incident ticket is evaluated by analyzing data associated with the incident ticket. Further, completeness of incident resolution of the incident ticket is determined based on the analysis. The completeness of the incident resolution is determined by comparing the incident resolution with an expected incident resolution.

The systems and methods further determine user-agent interaction based on the analysis of the data associated with the incident ticket. The user-agent interaction is determined based on at least one of an agent response coherence or a user response sentiment. The agent response coherence is based on relevancy of an agent response to the incident ticket. The user response sentiment is determined based on a user response to the incident ticket.

The systems and methods further determine timeliness of response based on the analysis of the data associated with the incident ticket. The timeliness of response is based on at least one of time consumed in an incident open state, time consumed in assigning an agent for the incident ticket, or time consumed in the incident resolution.

In one implementation, the incident ticket is rated based on the completeness of the incident resolution. In another implementation, the incident ticket is rated based on the completeness of the incident resolution, the user-agent interaction, and the timeliness of response. Upon rating the incident ticket, the incident ticket is categorized based on the rating of the incident ticket. Further, the evaluation of the incident ticket is updated based on a user feedback on the categorization of the incident ticket.

The systems and methods may be implemented in a variety of computing systems. The computing systems that can implement the described method(s) include, but are not limited to a server, a desktop personal computer, a notebook or a portable computer, hand-held devices, and a mainframe computer. Although the description herein is with reference to certain computing systems, the systems and methods may be implemented in other computing systems, albeit with a few variations, as will be understood by a person skilled in the art.

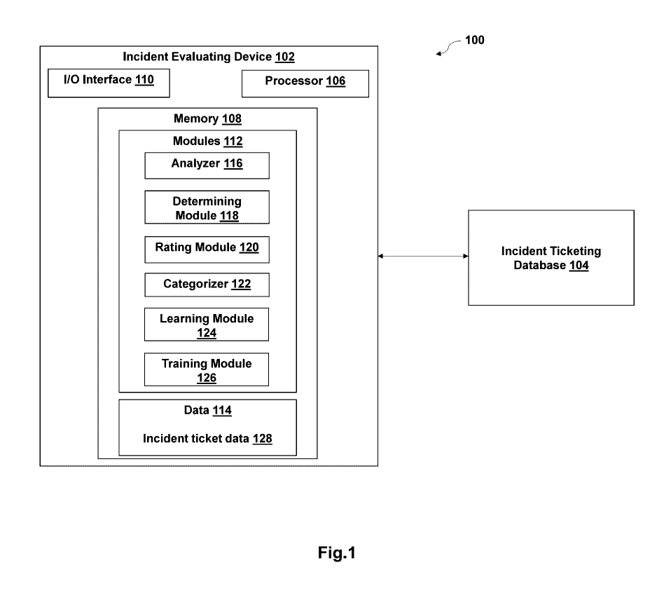

Working of the systems and methods for evaluating the incident ticket is described in conjunction with FIGS. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network implementation 100 comprising an incident evaluating device 102 for evaluating an incident ticket according to some embodiments of the present disclosure. As shown in the FIG. 1, the incident evaluating device 102 is communicatively coupled to an incident ticketing database 104. In one implementation, the incident ticketing database 104 may be present within the incident evaluating device 102.

The incident ticketing database 104 may comprise one or more incident tickets. The one or more incident tickets may be open incident tickets, pending incident tickets, closed incident tickets, or resolved incident tickets. Further, the incident ticketing database may also comprise expected incident resolution for each incident ticket.

The incident evaluating device 102 may be communicatively coupled to the incident ticketing database 104 through a network. The network may be a wireless network, wired network or a combination thereof. The network can be implemented as one of the different types of networks, such as intranet, local area network (LAN), wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network may include a variety of network devices, including routers, bridges, servers, computing devices, storage devices, etc.

As shown in the FIG. 1, the incident evaluating device 102 comprises a processor 106, a memory 108 coupled to the processor 106, and input/output (I/O) interface(s) 110. The processor 106 may be implemented as one or more microprocessors, microcomputers, microcontrollers, digital signal processors, central processing units, state machines, logic circuitries, and/or any devices that manipulate signals based on operational instructions. Among other capabilities, the processor 106 is configured to fetch and execute computer-readable instructions stored in the memory 108. The memory 108 can include any non-transitory computer-readable medium known in the art including, for example, volatile memory (e.g., RAM), and/or non-volatile memory (e.g., EPROM, flash memory, etc.).

The I/O interface(s) 110 may include a variety of software and hardware interfaces, for example, a web interface, a graphical user interface, etc., allowing the incident evaluating device 102 to interact with user devices, and the incident ticketing database 104. Further, the I/O interface(s) 110 may enable the incident evaluating device 102 to communicate with other computing devices. The I/O interface(s) 110 can facilitate multiple communications within a wide variety of networks and protocol types, including wired networks, for example LAN, cable, etc., and wireless networks such as WLAN, cellular, or satellite. The I/O interface(s) 110 may include one or more ports for connecting a number of devices to each other or to another server.

In one implementation, the memory 108 includes modules 112 and data 114. In one example, the modules 112, amongst other things, include routines, programs, objects, components, and data structures, which perform particular tasks or implement particular abstract data types. The modules 112 and may also be implemented as, signal processor(s), state machine(s), logic circuitries, and/or any other device or component that manipulate signals based on operational instructions. Further, the modules 112 can be implemented by one or more hardware components, by computer-readable instructions executed by a processing unit, or by a combination thereof.

In one implementation, the data 114 serves, amongst other things, as a repository for storing data fetched, processed, received and generated by one or more of the modules 112. In one implementation, the data 114 may include incident ticket data 128 (data associated with the incident ticket). In one embodiment, the data 114 may be stored in the memory 108 in the form of various data structures. Additionally, the aforementioned data can be organized using data models, such as relational or hierarchical data models. In an example, the data 114 may also comprise other data used to store data, including temporary data and temporary files, generated by the modules 112 for performing the various functions of the incident evaluating device 102.

In one implementation, the modules 112 further include an analyzer 116, a determining module 118, a rating module 120, a categorizer 122, a learning module 124, and a training module 126. In an example, the modules 112 may also comprises other modules. The other modules may perform various miscellaneous functionalities of the incident evaluating device 102. It will be appreciated that such aforementioned modules may be represented as a single module or a combination of different modules.

In order to evaluate the incident ticket, the analyzer 116 may analyze the data associated with the incident ticket. The data associated with the incident ticket may be alternatively referred to as the incident ticket data 128. The incident ticket data 128 may include time related data, user-agent interaction data, and incident resolution data. The time related data may include time at which the incident ticket is raised, the time at which an agent is assigned to the incident ticket, the time at which the incident ticket is updated, the time at which the incident ticket is resolved, the time at which the incident ticket is closed, and the like. The user-agent interaction data may include a request or a query from a user, public comments, agent response, and the like. The incident resolution data may include the incident resolution, expected incident resolution, and the like.

Upon analysis of the incident ticket data 128, the determining module 118 may determine completeness of the incident resolution for the incident ticket based on the analysis of the incident ticket data 128. The completeness of the incident resolution may be determined by comparing the incident resolution with the expected incident resolution. The expected incident resolution may be retrieved from the incident ticketing database 104. In order to compare the incident resolution with the expected incident resolution, the determining module 118 may perform a natural language processing on sentences present in the incident resolution and the expected incident resolution. Further, the determining module 118 may perform a similarity analysis of the incident resolution and the expected incident resolution to yield the completeness of the incident resolution. The completeness of the incident resolution may be one of a full resolution, a partial resolution, and an incorrect resolution. The determining module 118 may also provide a match percentage computed based on comparing the incident resolution with the expected incident resolution.

After determining the completeness of the incident resolution, the rating module 120 may rate the incident ticket based on the completeness of the incident resolution. In order to rate the incident ticket, the rating module 120 may compute a completeness score. The completeness score represents the completeness of the incident resolution. In one implementation, the completeness score may vary between ‘0’ and ‘1’. For example, if the completeness of the incident resolution is the full resolution, the completeness score may be computed as ‘1’. On the other hand, if the completeness of the incident resolution is the incorrect resolution, the completeness score may be computed as ‘0’. If the completeness of the incident resolution is the partial resolution, the completeness score may be computed based on the match percentage computed for the incident resolution and the expected incident resolution. For example, if the match percentage is 70%, the completeness of the incident resolution score may be ‘0.7’.

As the rating for the incident ticket is based on the completeness of the incident resolution, the rating for the incident ticket corresponds to the completeness score. Thus, the rating for the incident ticket may vary between ‘0’ to ‘1’. The rating for the incident ticket indicates quality of the evaluation of the incident ticket, thereby indicating the quality of the incident resolution.

In order to evaluate the incident ticket, in some implementations, the determining module 118 may determine the user-agent interaction based on the analysis of the incident ticket data 128. The user-agent interaction may be determined based on at least one of an agent response coherence or a user response sentiment. The agent response coherence may be determined based on relevancy of an agent response to the incident ticket. In order to determine the relevancy of the agent response to the incident ticket, the determining module 118 may extract intent of the incident ticket and intent of the agent response. The intent of the agent response and the intent of the incident ticket may be extracted by using a model trained on historical data. Further, the intent of the incident ticket and the intent of the agent response may be compared semantically. If the intent of the incident ticket and the intent of the agent response is identical, the agent response may be deemed coherent.

For example, if the incident ticket comprises a question, “How do I reset my password?”, the intent of the question may be determined as “Reset my password” by the determining module 118. Further, if the agent response to the question is “To reset the password you would need to log into account services and select Reset password”, then the intent of the agent response may be determined as “Reset the password”. Since the intent of the response is in line with the intent of the question or is coherent with the question, the agent response may be deemed coherent.

In another example, if the agent response to the question “How do I reset my password?” is “To connect to internet you would need to update your proxy password”, the intent of the agent response may be determined to be “Connect to internet.” As the intent of the agent response is not in line with the intent of the incident ticket, the agent response may be deemed non-coherent.

In addition to determining the agent response coherence, the determining module 118 may further determine the user response sentiment. The user response sentiment may be determined based on a user response to the incident ticket. To determine the response sentiment, a corpus may be maintained in the data 114 mapping particular phrases to one or more sentiments. The determining module 118 may match phrases present in the user response to phrases in the corpus to identify one or more sentiments associated with the user response. If a phrase from the user response does not match any phrases in the corpus, the sentiment for that phrase may be considered Neutral.

Further, a phrase may comprise terms which reverse the polarity of the phrase. The terms which reverse the polarity of the phrase are separately tracked. The phrases which comprise polarity inverters are evaluated for mapping of the sentiment based on pre-defined rules. For example, if the user response is “You are awesome.” The term ‘you’ may be considered as ‘neutral’, the term ‘are’ may be considered as ‘neutral’, and the term ‘awesome’ may be considered as ‘highly positive.’ Thus, the user response sentiment may be determined to be ‘highly positive.’ In another example, if the user response is ‘You are not awesome.’ The term ‘you’ may be considered as ‘neutral’, the term ‘are’ may be considered as ‘neutral’, and the term ‘awesome’ may be considered as ‘highly positive.’ However, the user response comprises of the term ‘not’ which is a polarity inverter. Therefore, the user response sentiment may be considered to be ‘negative.’

Evaluating the incident ticket may further comprise determining timeliness of response based on the analysis of the incident ticket data 128. The determining module 118 may determine the timeliness of the response based on at least one of time consumed in an incident-open state, time consumed in assigning an agent for the incident ticket, or time consumed in the incident resolution. The determining module 118 may compute the time consumed in an incident-open state based on the time at which the incident ticket is raised and the time at which the incident ticket is closed. Similarly, the time consumed in assigning the agent for the incident ticket may be computed based on the time at which the ticket is raised and the time at which the agent is assigned. The time consumed in the incident resolution may be computed based on the time at which the incident ticket is raised and the time at which the incident ticket is closed.

Moreover, the determining module 118 may also compute the timeliness of response based on time consumed on the incident ticket in pending state for software or hardware dependencies and the time consumed on the incident ticket in pending state for user's feedback.

In some implementations, to evaluate the incident ticket, the rating module 120 may rate the incident ticket based on the user-agent interaction, the timeliness of response, and the completeness of the incident resolution. In order to rate the user-agent interaction, the rating module 120 may compute an interaction score. The interaction score represents the user-agent interaction. The interaction score may be computed based on the agent response coherence and the user response sentiment. The rating module 120 may convert the agent response coherence to a coherence score. In one implementation, the coherence score may vary between ‘0’ and ‘1’. For example, if the agent response is deemed coherent, the coherence score may be determined as ‘1’. If the agent response is deemed non-coherent, the coherence score may be determined as ‘0’.

Similarly, the rating module 120 may convert the user response sentiment to a sentiment score. In one implementation, the sentiment score may vary between ‘0’ and ‘1’. For example, if the user response sentiment is highly positive, the sentiment score may be determined as ‘1’. If the user response sentiment is highly negative, the sentiment score may be determined as ‘0’. The user response sentiment may be normalized to the sentiment score with ‘1’ indicating highest satisfaction of the user.

Further, the rating module 120 may compute a weighted average of the coherence score and the sentiment score to compute the interaction score. Thus, the interaction score may vary between ‘0’ and ‘1’.

In one implementation, the rating module 120 may compute a timeliness score based on time taken to close the incident ticket. The timeliness score represents the timeliness of response. The time taken to close the incident ticket may be determined based on the time at which the incident ticket is raised, the time at which the incident ticket is closed, and the time for which the incident ticket is in the pending state. Further, the time taken to close the incident ticket may be normalized to determine the timeliness score.

In one example, the timeliness score may be computed based on a difference between expected time to close the incident ticket and the time taken to close the incident ticket. The expected time to close the incident ticket may be retrieved from the incident ticketing database 104. The timeliness score may be computed by taking into account a complexity of the incident ticket. The complexity of the incident ticket may be also retrieved from the incident ticketing database 104.

Further, the timeliness score may vary between ‘0’ and ‘1’. The timeliness score of ‘1’ may indicate maximum adherence to expected timeliness of response and the timeliness score of ‘0’ may indicate least adherence to the expected timeliness of response.

In order to compute the rating of the incident ticket, the rating module 120 may compute a weighted average of the completeness score, the interaction score, and the timeliness score.

After rating the incident ticket, the categorizer 122 may categorize the incident ticket based on the rating of the incident ticket. In one implementation, the categorizer 122 may categorize the incident ticket into ‘Very Good’, ‘Good’, ‘Neutral’, ‘Poor’, and ‘Very Poor’. As the rating of the incident ticket indicates the quality of the incident resolution, the categories are defined to indicate the quality of the incident resolution. For example, if the rating of the incident ticket is ‘1’, the incident ticket may be categorized as ‘Very Good’. Similarly, if the rating of the incident ticket is ‘0’, the incident ticket may be categorized as ‘Very Poor’.

Further, the learning module 124 may update the evaluation of the incident ticket based on a user feedback on the categorization of the incident ticket. In one implementation, the learning module 124 may display the rating of the incident ticket and the categorization of the incident ticket to the user after closing the ticket. Further, the learning module 124 may allow the user to update the category of the incident ticket. The learning module 124 may monitor the user feedback on the categorization of the incident ticket. If the user feedback on the categorization of the incident ticket is different from the categorization performed by the categorizer 122, the details related to the incident ticket may be fed back to the training module 126. The training module 126 may provide the updated category to the categorizer 122. Further, the evaluation and the categorization of a next incident ticket may be based on the updated categorization of previous incident tickets. Thus, the evaluation of the incident ticket and the categorization of the incident ticket may improve based on the user feedback.

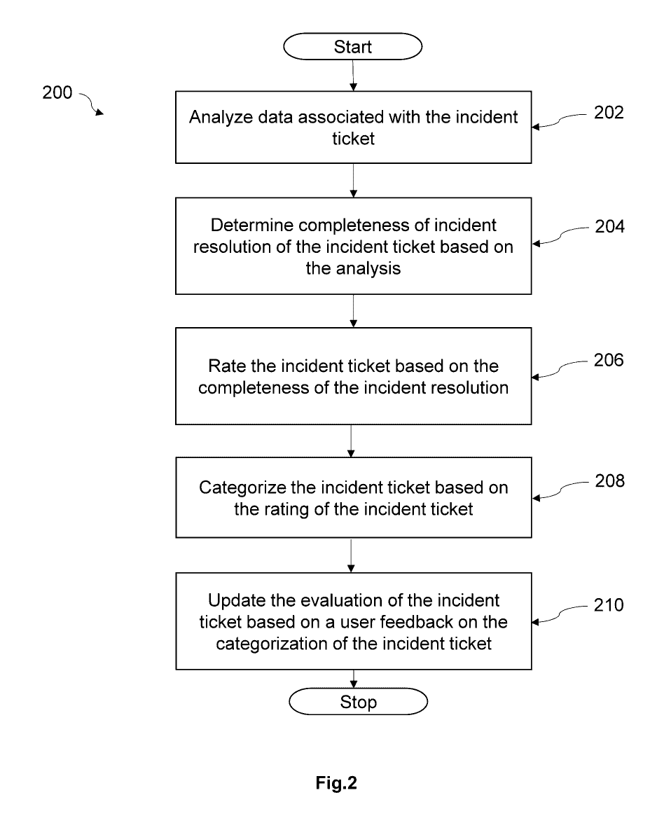

FIG. 2 is a flow diagram illustrating an example of a method 200 for evaluating the incident ticket in accordance with some embodiments of the present disclosure.

The method 200 may be described in the general context of computer executable instructions. Generally, computer executable instructions can include routines, programs, objects, components, data structures, procedures, modules, and functions, which perform particular functions or implement particular abstract data types. The method 200 may also be practiced in a distributed computing environment where functions are performed by remote processing devices that are linked through a communication network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternative methods. Additionally, individual blocks may be deleted from the method 200 without departing from the spirit and scope of the subject matter described herein. Furthermore, the method 200 can be implemented in any suitable hardware, software, firmware, or combination thereof.

With reference to the FIG. 2, at block 202, data associated with the incident ticket is analyzed. The data associated with the incident ticket may include time related data, user-agent interaction data, and incident resolution data. The time related data may include time at which the incident ticket is raised, the time at which an agent is assigned to the incident ticket, the time at which the incident ticket is updated, the time at which the incident ticket is resolved, the time at which the incident ticket is closed, and the like. The user-agent interaction data may include a request or a query from a user, public comments, agent response, and the like. The incident resolution data may include the incident resolution, expected incident resolution, and the like. In one implementation, the analyzer 116 may analyze the data associated with the incident ticket.

At block 204, completeness of incident resolution for the incident ticket may be determined based on the analysis of the data associated with the incident ticket. The determining module 118 may determine the completeness of incident resolution. The completeness of the incident resolution may be determined by comparing the incident resolution and the expected resolution. In order to compare the incident resolution with the expected incident resolution, the determining module 118 may perform a natural language processing on sentences present in the incident resolution and the expected incident resolution. The execution of the determining module 118 to determine the completeness of the incident resolution is explained in detail in conjunction with the FIG. 1.

Further, user-agent interaction and timeliness of response may be determined based on the analysis of the data associated with the incident ticket. The determining module 118 may determine the user-agent interaction and the timeliness of response. The user-agent interaction may be determined based on at least one of an agent response coherence or a user response sentiment. The agent response coherence may be determined based on relevancy of an agent response to the incident ticket. The user response sentiment may be determined based on a user response to the incident ticket. The execution of the determining module 118 to determine the user-agent interaction is explained in detail in conjunction with FIG. 1.

The determining module 118 may determine the timeliness of the response based on at least one of time consumed in an incident-open state, time consumed in assigning an agent for the incident ticket, or time consumed in the incident resolution. The execution of the determining module 118 to determine the timeliness of response is explained in detail in conjunction with the FIG. 1.

At block 206, the incident ticket may be rated based on the completeness of the incident resolution. The rating module 120 may rate the incident ticket based on the completeness of the incident resolution. In order to rate the incident ticket, the rating module 120 may compute a completeness score. The completeness score represents the completeness of the incident resolution. The execution of the rating module 120 to rate the incident ticket is explained in detail in conjunction with FIG. 1.

In some implementations, the rating module 120 may rate the incident ticket based on the user-agent interaction, the timeliness of response, and the completeness of the incident resolution. In order to rate the user-agent interaction, the rating module 120 may compute an interaction score and a timeliness score. The execution of the rating module 120 to rate the incident ticket is explained in detail in conjunction with FIG. 1.

At block 208, the incident ticket may be categorized based on the rating of the incident ticket. The categorizer 122 may categorize the incident ticket based on the rating of the incident ticket. The execution of the categorizer 122 to categorize the incident ticket is explained in detail in conjunction with the FIG. 1.

At block 210, evaluation of the incident ticket is updated based on a user feedback on the categorization of the incident ticket. The learning module 124 may update the evaluation of the incident ticket based on the user feedback on the categorization of the incident ticket. The execution of the learning module 124 to update the evaluation of the incident ticket is explained in detail in conjunction with the FIG. 1.

The incident evaluating device 102 and the method disclosed herein evaluates the incident ticket by rating the incident ticket based on the completeness of the incident resolution, the timeliness of response, and the user-agent interaction. Thus, both qualitative and quantitative parameters are considered for evaluating the incident ticket. As the evaluation of the incident ticket is based on the qualitative and quantitative parameters, the evaluation of the incident ticket is objective and accurate.

In addition, the incident evaluating device 102 and the method dynamically computes the rating of the incident ticket based on the user-agent interaction, the timeliness of response, and the completeness of incident resolution. Therefore, the time for evaluating the quality of the incident resolution is reduced, thereby reducing overall time required for incident management.

### Computer System

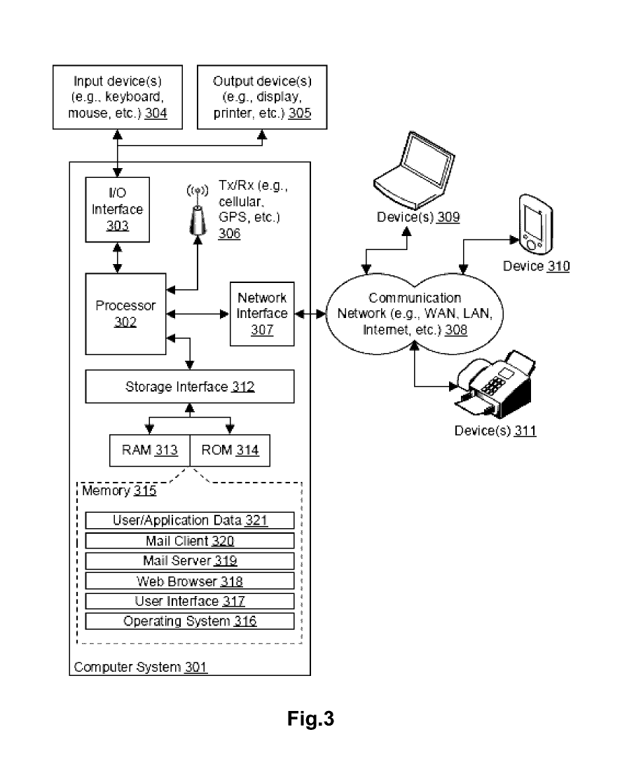

FIG. 3 is a block diagram of an exemplary computer system 301 for implementing embodiments consistent with the present disclosure, such as for the incident evaluating device 102 by way of example only. Variations of computer system 301 may also be used for implementing one or more of the analyzer 116, the determining module 118, the rating module 120, the categorizer 122, the learning module 124, and/or the training module 126. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for evaluating an incident ticket. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for evaluating an incident ticket, the method comprising:
analyzing, by an incident evaluating device, data associated with the incident ticket;
determining, by the incident evaluating device, completeness of incident resolution of the incident ticket based on the analysis; and
rating, by the incident evaluating device, the incident ticket based on the completeness of the incident resolution.

2. The method of claim 1, further comprising determining user-agent interaction based on the analysis.

3. The method of claim 2, wherein the user-agent interaction is determined based on at least one of an agent response coherence or a user response sentiment.

4. The method of claim 3, wherein the agent response coherence is based on relevancy of an agent response to the incident ticket.

5. The method of claim 3, wherein the user response sentiment is determined based on a user response to the incident ticket.

6. The method of claim 1, wherein determining the completeness of the incident resolution comprises comparing the incident resolution with an expected incident resolution.

7. The method of claim 1, further comprising determining timeliness of response based on the analysis.

8. The method of claim 7, wherein the timeliness of response is based on at least one of time consumed in an incident-open state, time consumed in assigning an agent for the incident ticket, or time consumed in the incident resolution.

9. The method of claim 1, further comprising categorizing the incident ticket based on the rating of the incident ticket.

10. The method of claim 9, further comprising updating the evaluation of the incident ticket based on a user feedback on the categorization of the incident ticket.

11. An incident evaluating device for evaluating an incident ticket, the incident evaluating device comprising:
a processor; and
a memory communicatively coupled to the processor, wherein the memory stores processor instructions, which, on execution, causes the processor to:
analyze data associated with the incident ticket;
determine completeness of incident resolution of the incident ticket based on the analysis; and
rate the incident ticket based on the completeness of the incident resolution.

12. The incident evaluating device of claim 11, wherein the processor further determines user-agent interaction based on the analysis.

13. The incident evaluating device of claim 12, wherein the user-agent interaction is determined based on at least one of an agent response coherence or a user response sentiment.

14. The incident evaluating device of claim 13, wherein the agent response coherence is based on relevancy of an agent response to the incident ticket.

15. The incident evaluating device of claim 13, wherein the user response sentiment is determined based on a user response to the incident ticket.

16. The incident evaluating device of claim 11, wherein the processor further compares the incident resolution with an expected incident resolution to determine the completeness of the incident resolution.

17. The incident evaluating device of claim 11, wherein the processor further determines timeliness of response based on the analysis.

18. The incident evaluating device of claim 17, the timeliness of response is based on at least one of time consumed in an incident-open state, time consumed in assigning an agent for the incident ticket, or time consumed in the incident resolution.

19. The incident evaluating device of claim 11, wherein the processor further categorizes the incident ticket based on the rating of the incident ticket.

20. A non-transitory computer-readable medium storing computer-executable instructions for:
analyzing data associated with the incident ticket;
determining completeness of incident resolution of the incident ticket based on the analysis; and
rating the incident ticket based on the completeness of the incident resolution.
